(19) United States
(12) Patent Application Publication
(10) Pub. No.: US 2010/0316885 A1
(43) Pub. Date: Dec. 16, 2010

(54) Assembly method by reactive brazing and vacuum cartridge assembled according to this method

(75) Inventors: Marie-Francoise Devismes, Bernin (FR); Dominique Mazzucchi, Jarrie (FR); Hans Schellekens, La Terrasse (FR); Olga Kozlova, Montbonnot (FR)

Correspondence Address: STEPTOE & JOHNSON LLP, 1330 CONNECTICUT AVENUE, N.W., WASHINGTON, DC, 20036, US

(73) Assignee: SCHNEIDER ELECTRIC INDUSTRIES SAS, Rueil Malmaison (FR)

(21) Appl. No.: 12/801,445

(22) Filed: Jun. 9, 2010

(30) Foreign Application Priority Data
Jun. 15, 2009 (FR) 09 02894

(51) Int. Cl. B32B 1/02; B23K 31/02; B32B 15/01

(52) U.S. Cl. 428/615; 228/198

(57) ABSTRACT

The present invention relates to an assembly method by reactive brazing of a first metallic element such as an end cover plate of a vacuum cartridge with a second element such as the cylindrical body of said cartridge, said second element comprising an ion-covalent oxide at least at the surface by means of an alloy called added alloy designed to constitute a liquid brazing alloy designed to wet the two respectively metallic and ion-covalent oxide surfaces to be assembled of the above-mentioned two elements, said brazing alloy containing titanium and said metallic element containing nickel. This method is characterized in that in the case where the percentage by weight of the alloy elements content of the metal which can form intermetallic compounds with titanium is less than 20%, the titanium content in the brazing alloy is comprised between 2% and 5% by weight, and in the case where the percentage by weight of the alloy elements content of the metal which can form intermetallic compounds with titanium metal to be assembled is comprised between 20% and 50%, this titanium content is chosen between 5% and 10%, and in the case where the percentage by weight of the alloy elements content of the metal which can form intermetallic compounds with titanium is more than 50%, this titanium content is chosen between 2% and 5% and the percentage by weight of Ag is less than 60% so as to minimize the non-wettability areas on the surface of the second element made from ion-covalent oxide by forming a sufficiently thick and stable reactional layer at the interface of said element, and to minimize formation of intermetallic compounds in the brazed joint.

### BACKGROUND OF THE INVENTION

The present invention relates to an assembly method by reactive brazing of a first metallic element with a second element comprising an ion-covalent oxide at least at the surface by means of an alloy called added alloy designed to constitute a liquid brazing alloy designed to wet the two respectively metallic and ion-covalent oxide surfaces to be assembled of the above-mentioned two elements, said brazing alloy containing titanium and said metallic element containing nickel.

### STATE OF THE ART

The brazing technique consists in a manner known in itself in assembling two materials by means of a metal or an alloy called “added alloy” the melting point of which is lower than that of the materials to be assembled. To obtain a strong tightly sealed joint, the liquid brazing alloy has to wet the two surfaces to be assembled. The wetting quality is characterized by the wetting angle θ. If θ<40°, the wetting is good and a close bond can exist between the two materials to be assembled. If θ>55°, the wetting is weak and an intimate bond on an atomic scale will not be able to form at any point of the interface.

The ceramics from which vacuum cartridges are made are Al2O3 aluminas that are ion-covalent oxides such as zirconium oxide (ZrO2), magnesium oxide (MgO) etc, and have a very stable electronic structure that is hardly or not at all suitable for formation of strong bonds at the interface with a metallic phase. The wetting angles of these ceramics by brazes formed by non-reactive liquid metal alloys are greater than 90°, which is significant of a poor wettability of these ceramics by these brazes.

To perform assembly of the ceramic element with the metal element by brazing, it is therefore necessary either to perform prior metallization of the surface to be brazed or to use reactive brazing alloys. Performing prior metallization of the surface to be brazed is the most commonly used method and is the one that is adopted for vacuum cartridge aluminas. It consists most of the time in depositing a first layer of a few tens of microns of Moly-manganese on the alumina and in then sintering at high temperature (about 1500° C.) under wet hydrogen, and in then depositing a second layer of Nickel on the first layer and then sintering at about 950° C. under hydrogen. This alumina metallization operation which therefore comprises two deposition operations and two sintering operations is complex and costly.

The above-mentioned second method consists in using brazes containing elements having a chemical reactivity to alumina so as to form reaction products wettable by brazing. The reactive alloys developed to perform brazing between ceramic oxides such as alumina and metals are mainly AgCu-based and more often than not contain titanium as reactive element, but it is also possible to find vanadium, zirconium or niobium. Improvement of wetting of alumina by the brazing alloy is significant.

However, in the case of a heterogeneous braze between alumina and a metal such as the one used in vacuum cartridges, the use of reactive brazing alloys may present major drawbacks if the composition of the braze is poorly suited to metal to be assembled.

Although the chemical activity of the reactive element of the braze with metal is stronger than the chemical activity of the reactive element of the braze with alumina, a risk does in fact exist of a continuous metallic layer not being formed on the alumina and therefore of poor-wettability areas being created. These poor-wettability areas on the ceramic are so many visual defects that may generate sealing defects, in the case where tight sealing of the assembly is required. Furthermore, the assembly achieved presents a lower strength than that of an assembly performed with metallized alumina.

It can therefore be concluded from the foregoing that reactive brazing cannot be suitable for all types of assembly and that, in certain cases, it is preferable to use the metallization method.

### SUMMARY OF THE INVENTION

The present invention solves these problems and proposes an assembly method by reactive brazing that is able to be adapted to suit cases where the metallization method was preferable in the past, so as to obtain a good wettability of the brazing alloy and a good strength of the assembly for these particular cases.

For this purpose, the object of the present invention is to provide an assembly method of the above-mentioned kind, this method being characterized in that in the case where the percentage by weight of the alloy elements content of the metal which can form intermetallic compounds with titanium is less than 20%, the titanium content in the brazing alloy is comprised between 2% and 5% by weight, and in the case where the percentage by weight of the alloy elements content of the metal which can form intermetallic compounds with titanium metal to be assembled is comprised between 20% and 50%, this titanium content is chosen between 5% and 10%, and in the case where the percentage by weight of the alloy elements content of the metal which can form intermetallic compounds with titanium is more than 50%, this titanium content is chosen between 2% and 5% and the percentage by weight of Ag is less than 60% so as to minimize the non-wettability areas on the surface of the second element made from ion-covalent oxide by forming a sufficiently thick and stable reactional layer at the interface of said element, and to minimize formation of intermetallic compounds in the brazed joint.

According to a particular feature, the thickness of the reactional layer formed is greater than 3 μm.

According to another feature, the above-mentioned ion-covalent oxide is a ceramic.

According to another feature, the above-mentioned ceramic is one of the ceramics comprised in the group containing alumina (Al2O3), zirconium oxide (ZrO2) and magnesium oxide (MgO).

According to another feature, the brazing alloy contains AgCuTi.

According to a particular embodiment, the metallic element contains CuNi with a concentration by weight of Ni<20%, and the concentration by weight of titanium is then comprised between 2% and 5%.

According to another embodiment, the metallic element contains CuNi with a concentration by weight of Ni comprised between 20% and 50%, and the concentration by weight of titanium is then comprised between 5% and 10%.

According to another embodiment, the metallic element contains FeNi with a concentration by weight of Ni<8%, and the concentration by weight of titanium is more than 2% and less than 5%.

According to another feature, the metallic element contains FeNi with a concentration by weight of more than 28%, and the concentration by weight of titanium is more than 2% and less than 5% and the concentration by weight of silver of the braze is less than 60%.

According to another feature, the metallic element contains stainless steel with a concentration by weight of Ni comprised between 8% and 18%, and the concentration by weight of titanium is more than 2% and less than 5%.

According to another feature, the titanium is added in the form of deposition, on the surface containing the ion-covalent oxide or the metallic surface, of a sheet deposited on said surface or on the metal, or of powder or fine particles introduced into the added alloy.

According to another feature, in the case where the percentage by weight of the alloy elements content of the metal which can form intermetallic compounds with titanium is comprised between 20% and 50%, the percentage by weight of Ag is comprised between 60% and 71%, the percentage by weight of Cu is comprised between 26% and 36%, and the percentage by weight of Ti is comprised between 5% and 10%.

According to another feature, in the case where the percentage by weight of the alloy elements content of the metal which can form intermetallic compounds with titanium is greater than 50%, the percentage by weight of Ag is less than 60%, and the percentage by weight of Ti is comprised between 2% and 5%.

It is a further object of the present invention to provide a vacuum cartridge for a vacuum switch comprising a cylindrical body and two end cover plates, this cartridge being characterized in that at least one of the two end cover plates is assembled to the body of the cartridge by a method comprising the above-mentioned features taken alone or in combination.

### BRIEF DESCRIPTION OF THE DRAWINGS

But other advantages and features of the invention will become more clearly apparent from the following detailed description which refers to the accompanying drawings given for non-restrictive example purposes only and in which:

FIG. 1 is a schematic representation illustrating assembly of a metallic element and a ceramic element by means of reactive brazing,

FIG. 2 is a schematic representation, identical to the previous figure, but illustrating several particular embodiments of the method according to the invention,

FIG. 3 is a graphic representation illustrating on the y-axis the thickness of the reactional layer versus the percentage by weight of Ti represented on the x-axis,

FIG. 4 is an axial sectional view of a vacuum cartridge comprising two end cover plates fixed by the method according to the invention to the cylindrical part of the cartridge,

FIG. 5 is a graphic representation illustrating on the y-axis the probability of breaking and on the x-axis the breaking strength F (N) for two compositions of AgCuTi (72Ag, 28% Cu) braze with 3% and 5% by weight of Ti.

### DETAILED DESCRIPTION OF PREFERRED EMBODIMENTS

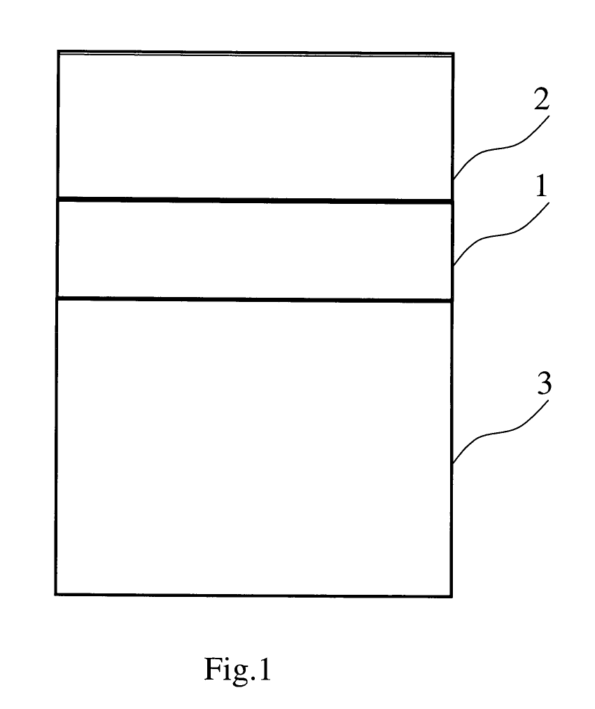

A diagram representing a reactive braze 1 made between a metallic element 2 and a ceramic element 3 is shown in FIG. 1.

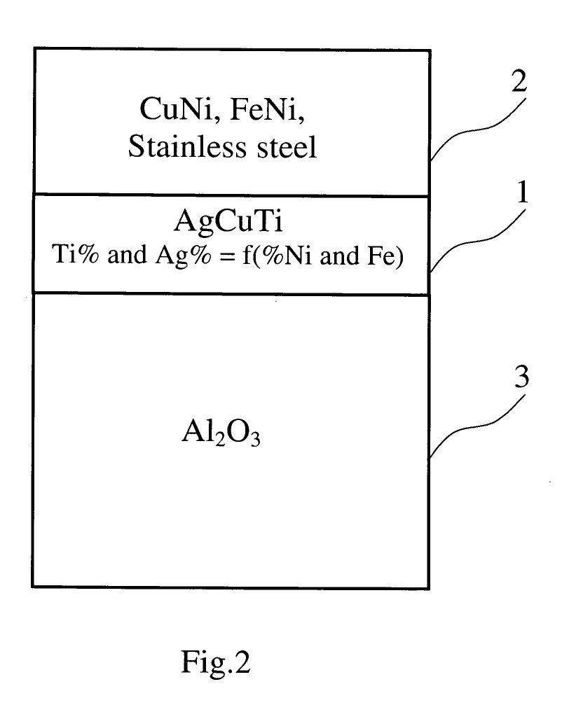

Several particular embodiments of the method wherein the metallic element 2 is either CuNi, or FeNi, or stainless steel have been indicated in FIG. 2. The brazing alloy 1 is AgCuTi, with a percentage of Ti according to the percentage of Ni and the percentage of Fe, and a percentage of Ag according to the percentage of Ni and of the percentage of Fe. The ion-covalent oxide 3 is a ceramic formed by alumina Al2O3.

According to the invention, the method consists in making a reactive braze between a metallic element containing Nickel and an element containing an ion-covalent oxide at the surface by means of a reactive braze containing titanium, and in adjusting the titanium weight content so as form a sufficiently thick and stable reactional layer on the element containing an ion-covalent oxide so as to minimize the non-wettability areas on the ion-covalent oxide.

This titanium content is also adjusted so as to maintain the percentage of inter-metallic compounds formed below a certain value, this percentage of intermetallic compounds having an influence on the strength of the braze formed.

According to a particular embodiment of the invention, the metallic element is CuNi with Ni<20 (by weight). In this case, the titanium content will be adjusted so as to be greater than 2% and lower than 5% (by weight).

In the case where the metallic element is CuNi with Ni comprised between 20% and 50% (by weight), the titanium content will be greater than 5% and lower than 10% (by weight).

In the case where the metallic element is FeNi with Ni<8% (by weight), the titanium content will be greater than 2% and lower than 5% (by weight).

In the case where the metallic element is FeNi with a concentration of Ni around 30% (by weight), the titanium content will be greater than 2% (by weight) and lower than 5% (by weight) and the silver content of the braze will be lower than 60% (by weight).

In the case where the metallic element is stainless steel with a concentration of Ni comprised between 8% and 18%, the titanium content will be greater than 2% and lower than 5% (by weight).

According to a particular embodiment, the brazing alloy is AgCuTi and the ion-covalent oxide is alumina.

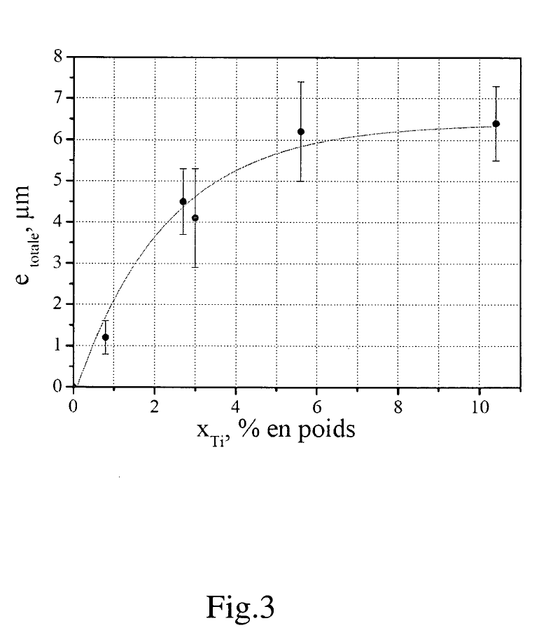

In FIG. 3, a graphic representation can be seen illustrating the thickness of the reactional layer formed in μm versus the titanium content (X Ti % by weight) present in the alloy for an assembly between the ion-covalent oxide and a metal devoid of an element presenting a chemical activity with the reactive element of the braze, here for example between alumina (Al2O3) and copper (Cu).

It can thus be seen that for a percentage by weight of Ti comprised between 2 and 5%, the thickness of the reactional layer obtained will be comprised between 3 and 6 μm. Likewise, for a percentage of Ti comprised between about 5 and 10% by weight, the thickness of the reactional layer obtained will be comprised between 5 and 7 μm.

This thickness depends on the content of nickel or of an element presenting a chemical activity with the reactive element of the braze contained in the metallic element.

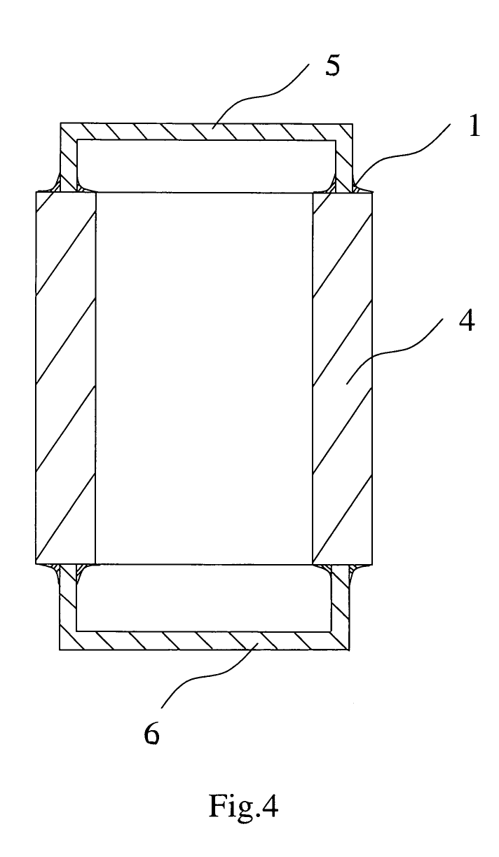

In FIG. 4, a vacuum cartridge A has been represented comprising a cylindrical body 4 made from ceramic on which two end cover plates 5,6 have been fixed by reactive brazing.

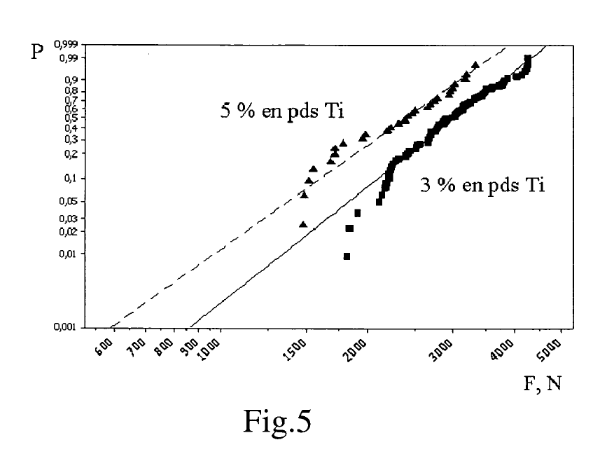

In FIG. 5, it can be seen that the probability of breaking at the level of the braze depends on the percentage by weight of titanium present in the braze material.

Thus, for a percentage by weight of titanium of 5%, the probability of breaking will be greater than that associated with a percentage by weight of titanium of 3%.

An assembly method by reactive brazing of an ion-covalent oxide with a metal has thereby been achieved according to the invention without a costly preliminary metallization step having to be performed, this method being able to be used even in cases where the metal to be assembled reacts greatly with the active element of the braze.

The invention applies to any type of assembly that requires a good tightness throughout the lifetime of the elements to be assembled, and/or an enhanced mechanical strength such as assembly of the end cover plates of a vacuum cartridge to the cylindrical part of the cartridge.

The invention applies to assembly of any material formed by an ion-covalent oxide with a metal containing Titanium provided that a Ti—O bond is possible.

The ion-covalent oxide can for example consist of a ceramic such as alumina, zirconium oxide, magnesium oxide etc.

1. Assembly method by reactive brazing of a first metallic element with a second element comprising an ion-covalent oxide at least at the surface by means of an alloy called added alloy designed to constitute a liquid brazing alloy designed to wet the two respectively metallic and ion-covalent oxide surfaces of the above-mentioned two elements, said brazing alloy containing titanium and said metallic element containing nickel,
wherein in the case where the percentage by weight of the alloy elements content of the metal which can form intermetallic compounds with titanium is less than 20%, the titanium content in the brazing alloy is comprised between 2% and 5% by weight, and in the case where the percentage by weight of the alloy elements content of the metal which can form intermetallic compounds with titanium metal to be assembled is comprised between 20% and 50%, this titanium content is chosen between 5% and 10%, and in the case where the percentage by weight of the alloy elements content of the metal which can form intermetallic compounds with titanium is more than 50%, this titanium content is chosen between 2% and 5% and the percentage by weight of Ag is less than 60% so as to minimize the non-wettability areas on the surface of the second element made from ion-covalent oxide by forming a sufficiently thick and stable reactional layer at the interface of said element, and to minimize formation of intermetallic compounds in the brazed joint.

2. Assembly method according to claim 1, wherein the thickness of the reactional layer formed is greater than 3 μm.

3. Assembly method according to claim 1, wherein the above-mentioned ion-covalent oxide is a ceramic.

4. Assembly method according to claim 3, wherein the above-mentioned ceramic is one of the ceramics comprised in the group containing alumina (Al2O3), zirconium oxide (ZrO2) and magnesium oxide (MgO).

5. Assembly method according to claim 1, wherein the brazing alloy contains AgCuTi.

6. Assembly method according to claim 1, wherein the metallic element contains CuNi with a concentration by weight of Ni<20%, and the concentration by weight of titanium is then comprised between 2% and 5%.

7. Assembly method according to claim 1, wherein the metallic element contains CuNi with a concentration by weight comprised between 20% and 50%, and the concentration by weight of titanium is then comprised between 5% and 10%.

8. Assembly method according to claim 1, wherein the metallic element contains FeNi with a concentration by weight of Ni<8%, and the concentration by weight of titanium is more than 2% and less than 5%.

9. Assembly method according to claim 1, wherein the metallic element contains FeNi with a concentration by weight of more than 28%, and the concentration by weight of titanium is more than 2% and less than 5% and the concentration by weight of silver of the braze is less than 60%.

10. Assembly method according to claim 1, wherein the metallic element contains stainless steel with a concentration by weight of Ni comprised between 8% and 18%, and the concentration by weight of titanium is more than 2% and less than 5%.

11. Assembly method according to claim 1, wherein the titanium is added in the form of deposition, on the surface containing the ion-covalent oxide or the metallic surface, of a sheet deposited on said surface or on the metal, or of powder or fine particles introduced into the added alloy.

12. Assembly method according to claim 5, wherein in the case where the percentage by weight of the alloy elements content of the metal which can form intermetallic compounds with titanium is comprised between 20% and 50%, the percentage by weight of Ag is comprised between 60% and 71%, the percentage by weight of Cu is comprised between 26% and 36%, and the percentage by weight of Ti is comprised between 5% and 10%.

13. Assembly method according to claim 5, wherein in the case where the percentage by weight of the alloy elements content of the metal which can form intermetallic compounds with titanium is greater than 50%, the percentage by weight of Ag is less than 60%, and the percentage by weight of Ti is comprised between 2% and 5%.

14. Vacuum cartridge for a vacuum switch comprising a cylindrical body and two end cover plates, wherein at least one of the two end cover plates is assembled to the body of the cartridge by a method according to claim 1.
